(19) United States
(12) Patent Application Publication
(10) Pub. No.: US 2002/0035502 A1
(43) Pub. Date: Mar. 21, 2002

(54) Method and apparatus for providing integrated corporate foundry services

(76) Inventor: Saiyed Atiq Raza, Palo Alto, CA (US)

Correspondence Address: DAVID A. JAKOPIN, PILLSBURY WINTHROP LLP, NINTH FLOOR, 1100 NEW YORK AVE, N.W., WASHINGTON, DC, 20005, US

(21) Appl. No.: 09/853,889

(22) Filed: May 10, 2001

Related U.S. Application Data
(63) Continuation-in-part of application No. 09/569,776, filed on May 12, 2000.

(51) Int. Cl. G06F 17/60

(52) U.S. Cl. 705/10; 705/11

(57) ABSTRACT

The present invention provides a method for structuring a group of companies. In this structure, a financial and organizational foundation, termed a foundry entity hereinafter, is provided that includes not only financial backers for each of the companies that are being developed by the foundry entity, but also a group of individuals who have a variety of technical, marketing and management and other backgrounds. The group of individuals from the foundry entity is assigned to different ones of the companies being developed by the foundry. The personnel then become active participants in their respectively assigned member companies and provide the companies with a high level of experience, which naturally improves the knowledge and experience of the original founders and new employees beyond their initial knowledge and experience levels. Advantages of the invention include a structured environment where a group of companies can grow effectively and rapidly. Another advantage is that the companies are tracked against general metrics and specific metrics to insure that they are in schedule. Since many of these companies are in related technical fields, the data and metrics used to track them are extremely useful for building the businesses.

### REFERENCE TO RELATED APPLICATIONS

This is a continuation-in-part of U.S. Ser. No. 09/569,776 filed May 12, 2000, incorporated herein by reference.

### FIELD

The present invention relates to an apparatus and method for providing integrated corporate foundry services. In particular, the invention provides a structure and method that defines a technology for building member companies sharing overlapping technical, marketing, management, legal and other expertise. The invention improves the corporate structure and improves the efficiency and speed to market of the particular member companies and their respective products and services.

### BACKGROUND

Startup companies are conventionally started by relatively few individuals called founders. The founders typically develop the core ideas on which to base the startup company's business plan. While the core ideas may set forth a new technology or a potentially successful business plan, executing the business plan to build a successful company is not always achieved.

Founders, whether they were previously at a large company, a successful startup, a unsuccessful startup, or other place of employment, will typically have a skill set in a certain field, but need assistance in other fields. Thus, a founder may have a technical, marketing or management background, but will not typically have all three. Even if a founder does have a significant breadth of experience, a successful company that has grown beyond the startup stage will need different individuals in various technical, marketing, management and legal capacities in order to achieve recognition as an establishment in the business world.

Often consultants can be sought out and hired, assuming that the company recognizes the need for such advice. While consultants are often used to help provide depth, consultants in specific fields may not be available or may be so expensive that the company must delay the engagement until after raising additional capital. Further, although stock options can be used as currency to attract or pay for specialized employees or consultants, such employees or consultants may not be readily available or agreeable to such terms. Thus, a company may inadvertently or needlessly go without adequate skills or advice due in part to lack of recognition of the importance of the needed skills or the inability to pay for such skills. Such lack of skills can adversely affect the ability of the company to successfully execute its business plan.

As a company grows, the management will learn more about the actions necessary for the successful execution of its business plan, typically by making initial mistakes and false starts. When the company obtains more capital, the startup will then be able to add other qualified individuals to the organization, whether as employees or consultants, with the ultimate hope of succeeding in the business endeavor.

In order to gain office space and potential guidance, startups often turn to business incubators for assistance. Business incubators are known as places where a number of startup companies can grow from their initial founding team, and while in this growth stage share certain resources. Conventionally, incubators provide office space for the startup along with shared secretarial and other administrative resources. These administrative resources, however, do not provide advice, guidance and help on how to design, develop, produce, market and distribute the product or service that is the focus of the startup. Those tasks are left to the founders and other employees of the company. Further, while the owner of the incubator may take a financial stake in the companies that are associated with the incubator, and provide certain advice and guidance to the companies located therein (potentially even becoming a member of the company's board of directors), this is typically done on a case-by-case basis, and not systematically for each of the various companies that are associated with the incubator.

That is not to say that the startup, whether associated with an incubator or not, has been without any other resources to assist in financing the company, as well as designing, developing, producing, marketing and distributing the product or service. Typically, the board of directors and other oversight bodies are selected in part based upon their financial contribution to the company. The board of directors and other oversight bodies, such as technical advisory boards, intellectual property review committee and others are typically selected to help provide recommendations in a number of different areas, such the company's product or service, marketing plan, hiring plans and referrals, etc.

Referring again to incubators, another common characteristic of a conventional incubator is that it has many different types of companies housed within a single location. Those that can afford to rent the space and/or services then become part of the incubator. While this provides for companies of the same relative size to be in an environment that can assist in growing the startup, there is typically no relation between what the different companies are doing. Thus, while a number of companies may be focused on software development, other companies may be attempting to design hardware for a system, others may be developing semiconductor products, and still others may be developing new Internet related services. Moreover, when the company grows beyond a certain threshold, it will move out of the incubator location and need to provide its own secretarial and other administrative resources previously provided by the incubator.

There are also companies, including startups, that are founded outside of a business incubator. In certain of these instances, there are a group of companies that are funded by a common investor or group of investors, and that common investor or group will attempt to help each of the companies execute their business plan. This help, however, is of the type provided by a member of the board of directors or other oversight body. While helpful, roughly the same level of oversight, guidance and assistance to a company that is initially within an incubator and then outgrows it, since it board of directors and other oversight bodies will continue to provide advice and recommendations as the company moves into a new larger space and is no longer associated with the incubator.

As may be apparent from the description provided above, while a startup does have certain resources on which it can rely, the success of a given startup typically depends upon the successful execution by the founders, and the support which may come from others on a case-by-case basis. If the founders, board and other oversight bodies are knowledgeable and provide correct advice to a start up that is also well-funded, chances increase that this particular startup will succeed. Such a situation is conventionally haphazard, and it means that many potentially successful startups fail. Thus, while the model described above for starting new companies is possible, the success of a given company is highly dependent on the specific founders, its board and oversight bodies, and other intangibles.

Since the conventional incubator or venture capitalist often works with companies in a wide range of business fields, the organization has difficulty tracking each of the companies relative to other companies in a similar business. This leads to a lot of uncertainty regarding the progress of the startups and whether the businesses should add personnel at a specific point in time, launch specific marketing or advertising campaigns, etc.

More recently, there have been a few incubators that have offered a variant of the services offered by conventional incubators, such as companies like IdeaLab!, Internet Capital Group (ICG) and CMGI. For these new variants of incubators, there may primarily be companies having overlapping technical fields associated with the incubator, such as the Internet for ICG. Further, the various start-up companies are encouraged to cooperate with each other, and benefit from the experience of the other similarly situated start-ups that are part of this type of incubator. While this has advantages, what is still lacking, from the present inventor's perspective, is a strong organized core group for each of the foundry companies, which core group will help ensure the success of the particular foundry company

Accordingly, it has been recognized that there is a need for a more structured environment that overcomes the conventional limitations, and where a group of companies can grow more effectively and rapidly, without the missteps that oftentimes occur with a startup and potentially doom the startup to failure.

### SUMMARY

The invention supports a structured environment where a group of companies can grow more effectively and rapidly. In this structure, a financial and organizational foundation called a foundry entity is provided that supplies financial backing for each of the companies under development by the foundry entity, known as member companies, and also provides a group of foundry personnel who have a variety of technical, marketing, legal, management and other skills. In one aspect of the invention, the foundry entity is focused on a particular technological field or market. The group of foundry personnel is assigned to various member companies under development by the foundry. The personnel then become active participants in their respectively assigned member companies and provide the companies with a high level of experience, which naturally improves the knowledge and experience of the original founders and new employees beyond their initial knowledge and experience levels.

This group of foundry personnel, called a core foundry class, is composed of individuals who are stake holders of the foundry entity, employed by the foundry entity or both, on either a permanent or consulting basis. Individuals of this core foundry class are not directly employed by the member companies, however, these individuals assist the companies as part of their regular duties at the foundry entity.

According to the invention, certain members of the foundry personnel will also sit on the board of directors of the various member companies. This will often be a condition of the companies' membership with the foundry. In one aspect of the invention, the core foundry class assists each of the foundry companies by helping them develop a technical advisory board. In another aspect of the invention, the technical advisory boards for each of the member companies includes individuals outside the foundry entity who have particular industry affiliations, for example, managerial or executive positions in a potential customer company. Such outside individuals can offer keen insight into the particular needs or service requirements of the potential customer company.

The foundry personnel provide business strategy review and development, marketing strategy review and development and/or products and services review and development, and assist with suggestions for improvements to the products and services under development by the member companies. In some cases, the foundry personnel will help to develop the products and services and the associated business and marketing plans. The foundry personnel also assist the member companies in obtaining reviews from potential customers and in modifying the products and services under development in order to be attractive to the potential customers.

Additionally, the foundry entity provides progress monitoring and comparison to best practices, other companies in the foundry and/or the outside world. Best practices is a term that describes ideal management and conditions that can be achieved, or nearly achieved, in the foundry. The best practices are based at least in part on the industry and general business expertise of the foundry personnel. Each of the member companies in the foundry is monitored and various attributes of the companies are periodically collected and stored in a computer. These attributes can include number of employees, amount of financing, milestones, etc. The member companies' attributes over time are compared to general metrics, such as best practices metrics, and to other companies that are in development at the foundry or that have graduated the foundry. In this manner, the foundry entity can keep track of each of the companies' progress and assist the companies with support that is appropriate for each specific company. Often, this means ensuring best practices are integrated into the company.

With the structure implemented as described above, it is possible to more effectively perfect and execute a business plan on a more timely basis for each of many different member companies. If each of the companies within the foundry entity have the same technical orientation, the advantages become even more apparent, since the technical, marketing and management expertise that is available to the foundry entity can be fine tuned to that technical field.

In an additional aspect of the invention, the foundry entity may solicit and receive funds from various investors. In some cases, the investors will be seeking a return on their investment, and in other cases, the investors will be seeking a strategic relationship with the foundry entity. In cases of a strategic relationship, the investors may be corporations or other entities that will benefit from the access to the products or services offered by the member companies. Also, the investors may be given opportunities to invest in the member companies or even purchase the member companies to improve their respective positions in the marketplace. In still other cases, the foundry may solicit investments on behalf of the member companies from other sources, such as strategic corporate investors, who have not invested directly in the foundry.

Advantages of the invention include a structured environment where a group of companies can grow effectively and rapidly. Another advantage is that the companies are tracked against general metrics and specific metrics (e.g. best practices metrics) to ensure that they are in schedule. Since many of these companies are in related technical fields, the data and metrics used to track them are extremely useful for building the businesses.

### BRIEF DESCRIPTION OF THE DRAWINGS

The invention and its advantages are further described in the detailed description that follows with reference to the drawings, wherein:

FIG. 1 illustrates a diagram of the structure of the foundry system according to the present invention;

FIG. 2 is a chart showing several stages of a company in the foundry system;

FIGS. 3A-B are charts showing several stages of a company in the foundry system;

FIG. 4 is a chart showing several stages of a company in the foundry system;

FIG. 5 is a chart showing several stages of a company in the foundry system;

FIG. 6 is a flow chart showing a process of developing a member company and its respective product and/or services;

FIG. 7 is a flow chart showing a development path within a member company to develop its respective product and/or services;

FIGS. 8A-B show a computer system for collecting, storing, computing and tracking various attributes of the member companies as they are under development in the foundry;

FIGS. 9A-B are charts identifying the status of the member companies and the progress of the member companies based on certain attributes; and

FIGS. 10A-B are charts comparing a number of companies to one another based on certain attributes.

### DETAILED DESCRIPTION

The invention is described with reference to specific configurations, architectures and protocols. Those skilled in the art will recognize that this description is for illustration and to provide the best mode of practicing the invention, and is not meant to be limiting. For example, reference is made to a foundry but any such business architecture is applicable. Moreover, reference is made to using a program and database to track achievements and milestones of the member companies but other techniques are anticipated.

A. Overall Structure and Architecture of Foundry Entity

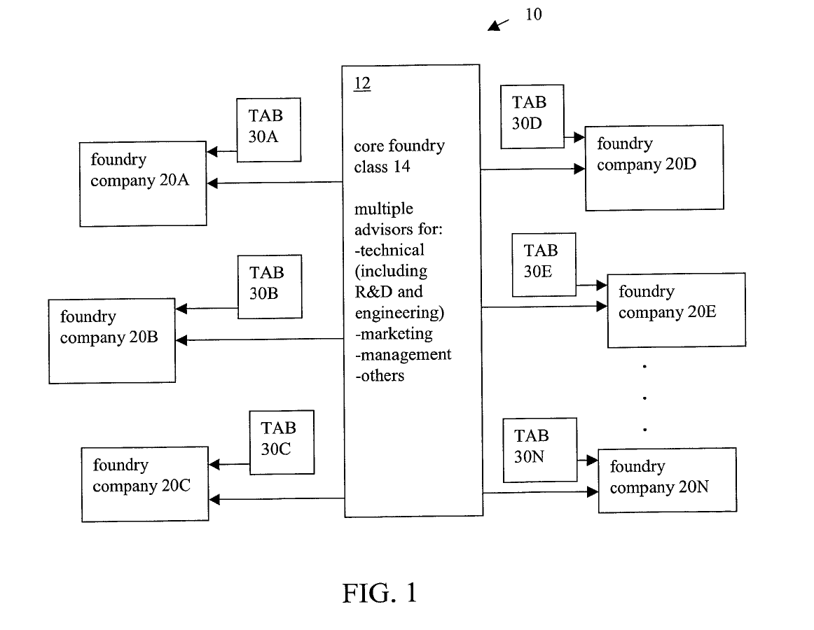

FIG. 1 illustrates a foundry system structure 10 for a group of member companies that are related as described below, and which includes a foundry entity 12 and a group of member companies 20A-20N. Most of the member companies are startups, but can also represent spin-offs from established companies or development projects intended to be spun-in with established companies. The member companies 20A-20N are denoted in that manner to illustrate that there may well be a large number of such companies 20 that are part of the foundry system structure. Each of the member companies has a relationship with the foundry entity 12 represented by a line in the figure. Additionally, each of the member companies will have an advisory board, for example a technical advisory board. FIG. 1 illustrates a number of technical advisory boards (TABs) 30A-30N each associated with a respective member company 20A-20N.

The foundry entity 12 is a legal entity such as a corporation or partnership, and preferably a corporation. Each of the member companies 20A-20N is also a legal entity and preferably a corporation. In the system described herein, the legal status of the different entities is significant since the interplay between the different entities is governed in part by the legal status of each.

The foundry entity 12 provides financial support as well as a group of foundry personnel who have a variety of technical, marketing, legal, management and other skills as described in detail below. The group of foundry personnel is assigned to various member companies under development by the foundry and offer overall organizational guidance to the member companies. The personnel then become active participants in their respectively assigned member companies and provide the companies with a high level of experience, which naturally improves the knowledge and experience of the original founders and new employees beyond their initial knowledge and experience levels. Additionally, the member companies may request specific assistance from the foundry entity, for example, assistance in designing a product or service. The foundry entity has personnel who can directly assist the member company with designing the product or services, or can at least supervise the member company personnel and/or outside contractors in such development. The foundry entity 12 has a financial and organizational incentive to help assist each of the companies 20. One part of this incentive is that the foundry entity 12 has an ownership stake in each of the member companies 20 that can range, for example, from 40-60 percent on initial participation by the foundry entity and preferably at least 25 percent upon formation of the member company corporate legal entity. The foundry entity 12 gains this equity interest in each of the member companies through a direct investment commitment, a services commitment or both. The foundry entity may also gain an equity interest in the member companies by assisting them achieve certain funding or other milestones.

In return for the equity ownership interest in any given member company 20, the member company agrees to allow a representative of the foundry entity 12 to become a member of its board of directors, which all corporations are required to have. The representative may be an employee or consultant of the foundry entity. As a result of maintaining this management status with each of the member companies, the foundry entity 12 is assured to be in a position to influence the actions taken by each of the member companies. If a potential member company does not agree to this arrangement, it may be refused membership in the foundry system, but can instead operate in a convention manner as described above.

A characteristic of the foundry entity 12 is the types of individuals that make up the foundry entity. This group of foundry personnel, called a core foundry class 14, is composed of individuals who are stake holders of the foundry entity, employed by the foundry entity or both, on either a permanent or consulting basis. Individuals of this core foundry class 14 are not directly employed by the member companies, however, these individuals assist the companies as part of their regular duties at the foundry entity. The foundry personnel have a variety of technical, marketing, legal, management and other backgrounds. This foundry personnel are assigned to the various member companies 20 under development by the foundry entity 12. The personnel assignment is such that at least one different individual having a technical, marketing, legal, and management background is assigned to each of the companies 20, thereby allowing each company 20 to obtain experience and expertise from each of these different areas of expertise that is beyond their initial skill level. Depending upon the number of different companies 20, there will be a number of different individuals having various backgrounds to ensure that each company 20 has the level of support it requires.

The core foundry class 14 are assigned to actively participate in the development of the various member companies 20 under development by the foundry entity 12. As a particular company, such as 20A in FIG. 1, grows and obtains the expertise previously provided by a specific core foundry individual then that core foundry individual no longer needed by that particular company 20A can be assigned to other member companies 20. The level of support provided by a specific core foundry individual 12 to a particular company 20 is highly dependent on the requirements of the company 20 at that time. Furthermore, in this foundry environment, it is preferably required that at least one of the members of the core foundry class 12 initially be a member of the board of directors of each of the companies 20. In any event, the core foundry class individual will actively participate similar to an employee of the company 20, such as developing product specifications, implementing an integrated circuit using integrated circuit design tools or negotiating licenses for one of the assigned companies.

As has been mentioned, within the core foundry class 14 there is preferably at least one individual whose background or expertise is technical, another whose background or expertise is marketing, another's whose background or expertise is corporate management guidance and another's whose background or expertise is legal. Depending upon the number of companies 20 that are part of the foundry system, the numbers of individuals having each of these skills will vary. The usage of the term “background” or “expertise” when referring to the skill set of the individuals described above is intended to connote that the person have a level of skill that will cause others to recognize their credentials. Put another way, the level of skill that each such person has would allow that person to testify as an expert in a court of law for the discipline that the person holds. Typically each of the people will have at least a college degree. Thus, a person whose background is broadband communications would have a bachelors or masters degree in communications, and preferably a number of years of work experience at a company that dealt in broadband communications. As another example, for the person whose background is legal, it is preferred that the person be a lawyer. It is most preferred that the person with a legal background be a corporate lawyer, since as noted above, compliance with the corporate requirements for each of the companies 20 is essential to the proper implementation of the foundry system described herein.

The present foundry system structure is developed so that there are a number of different individuals who have backgrounds in each of the expertise areas noted above. This ensures that a variety of different opinions and various specific types of expertise exist in the core foundry class. Further, it ensures that the requirements of a number of different types of companies 20 can be met. For example, in the area of technology, it is preferred that there are separate individuals who can provide advice on research and development inquiries, as distinct from engineering inquiries, thus providing a range of expertise to each of the companies 20 that they may not otherwise have within their company, particularly at the time they are started. Given that all companies require marketing, it is also preferred that there are a number of individuals who have a marketing background, for essentially the same redundancy reasons as described above, and particularly with a knowledge of the markets of the foundry companies 20. Moreover, the foundry entity has personnel who can directly assist the member company, or can at least supervise the member company personnel and/or outside contractors.

Using the described foundry system, if, for example, there are six different companies 20, and each has a person with a technical background, and another person with a marketing background as original founders, each of these different companies can then turn to the individuals in the core foundry class 14 to assist them in refining and executing their business plan. Further, they can have the individuals in the core foundry class 14 represent their company at meetings, negotiations, trade shows and the like, as well as design and develop product, and assist in teaching new hires the tools (such as CAD tools) used by the company. This helps ensure that each of the companies 20 has the personnel in place that are very necessary for success. As any of the companies 20 grow and hire new employees, they may no longer need as much time from certain individuals in the core foundry class 14 to be active participants to the extent that was previously needed. This allows the company to then further establish itself as an individual entity, and also allows the individuals from the core foundry class 14 to spend more of their time on other companies 20. One of the foundry entity's policies of operation is to actively assist the member companies to recruit and hire the personnel it needs to be self-sufficient. Over time, it is desired that the company 20 possess full resources with its own employees and does not necessarily need the services of any individuals in the core foundry class 14. Nonetheless, while the company may not technically need the services of any individuals in the core foundry class 14, it is desired that these individuals be available thereafter for consultation, thereby continuing to provide each company 20 with possible resources as needed.

It is further desired that the foundry system as described herein be implemented such that the companies 20 that are associated with the foundry entity 10 all share a similar technical orientation and marketplace, such as telecommunications, or, in even a more focused structure, broadband networking and communications, for instance. With this commonality between companies 20, the resource sharing of individuals as described further hereinafter, particularly at the startup stage, is most effective. This similarity of technical orientation and marketplace allow the foundry entity to devote significant resources to the member companies, which benefit in turn because the resource cost in certain technical fields (e.g. telecommunication) is very high. If each of the companies within the foundry entity have the same technical orientation, the advantages become even more apparent, since the technical, marketing and management expertise that is available to the foundry entity can be fine tuned to that technical field. Consequently, the foundry entity offers a great deal of value to the member companies, creating a highly synergistic relationship between the foundry entity and the member companies.

Another aspect of the foundry structure according to the invention is that the core foundry class assists each of the foundry companies by helping them develop a technical advisory board. This is illustrated in FIG. 1 by the reference to the technical advisory board 30, there being shown a specific and independent technical advisory board, 30A-30N in FIG. 1, for each different foundry company 20A-20N. In another aspect of the invention, the technical advisory boards for each of the member companies includes individuals outside the foundry entity who have particular industry affiliations, for example, managerial or executive positions in a potential customer company. Such outside individuals can offer keen insight into the particular needs or service requirements of the potential customer company. By developing an independent technical advisory board for each foundry company early in their formation process, this provides yet another level of sophistication to the foundry company that it might not otherwise have. In particular, since there are members who are not employed by the foundry, but are employed in some high level technical or executive capacity at a non-foundry related company in the industry that the foundry company is targeting, industry specific guidance can be provided. In the structure described above, it is preferable, but not required, for startup companies to be initially located in a single location, much like a conventional incubator. This allows the resource sharing of individuals to be highly effective.

In an additional aspect of the invention, the foundry entity may solicit and receive funds from various investors. In some cases, the investors will be seeking a return on their investment, and in other cases, the investors will be seeking a strategic relationship with the foundry entity. In cases of a strategic relationship, the investors may be corporations or other entities that will benefit from the access to the products or services offered by the member companies. Also, the investors may be given opportunities to invest in the member companies or even purchase the member companies to improve their respective positions in the marketplace. In still other cases, the foundry may solicit investments on behalf of the member companies from other sources, such as strategic corporate investors, who have not invested directly in the foundry.

B. Member Companies' Development Stages

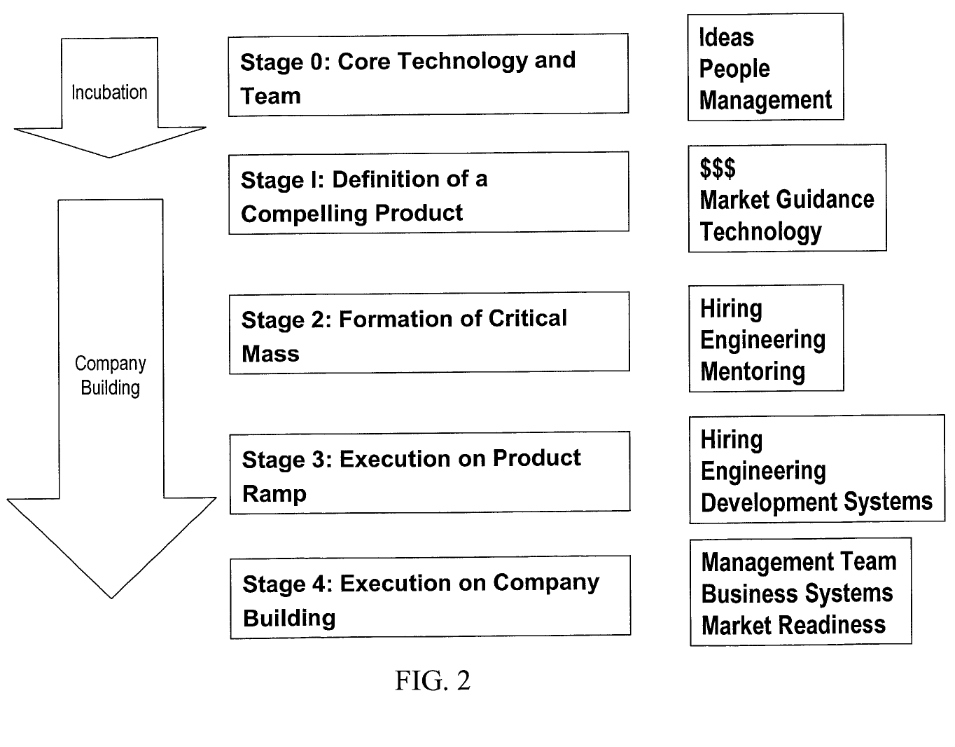

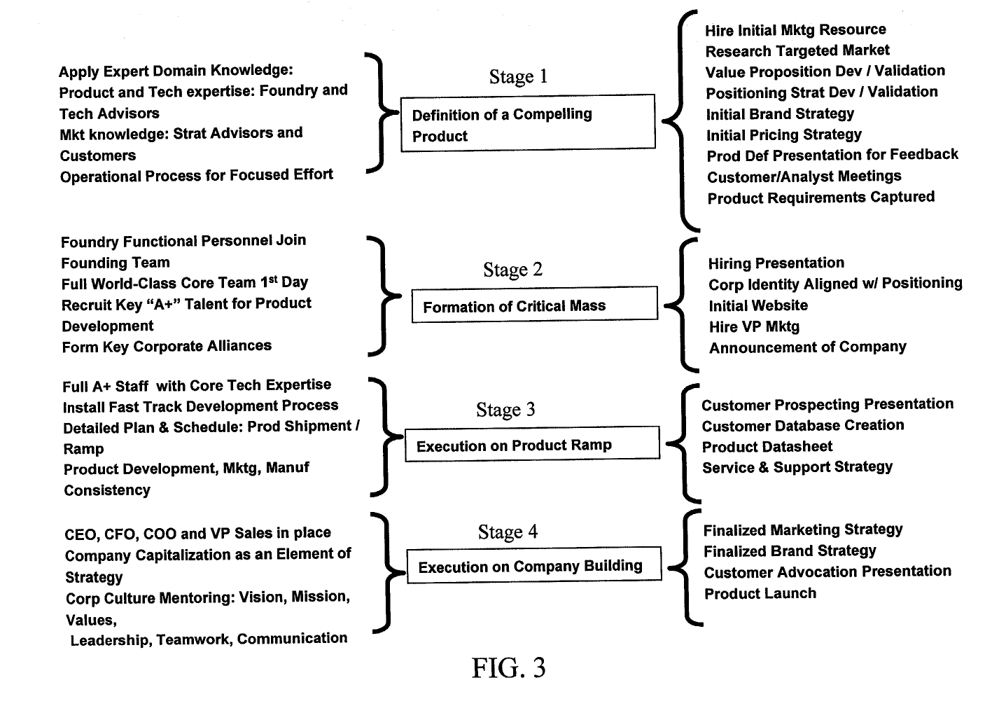

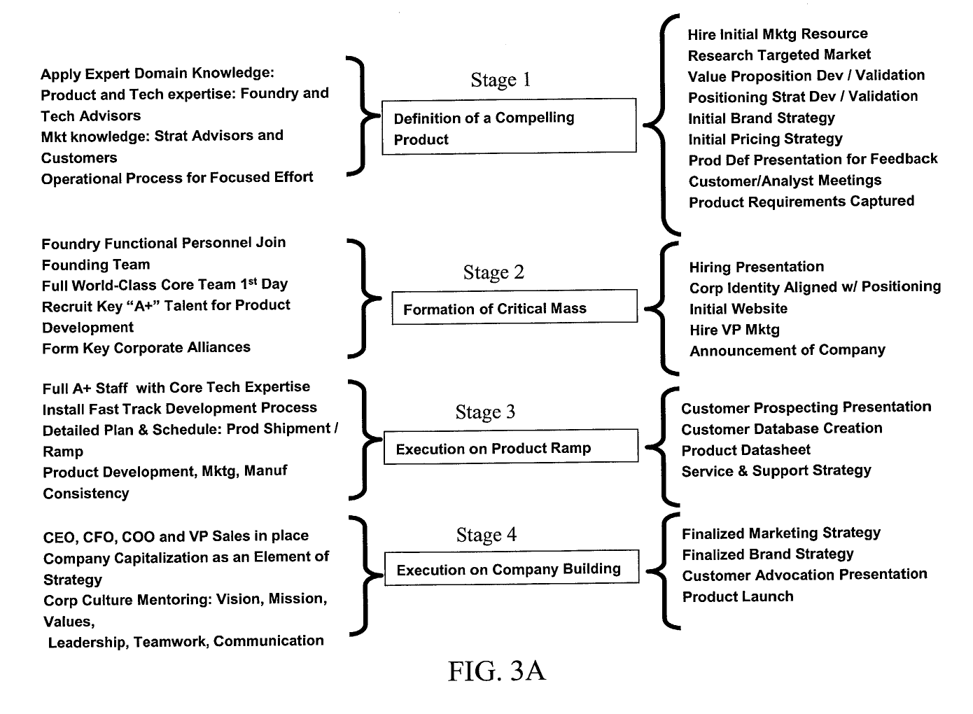

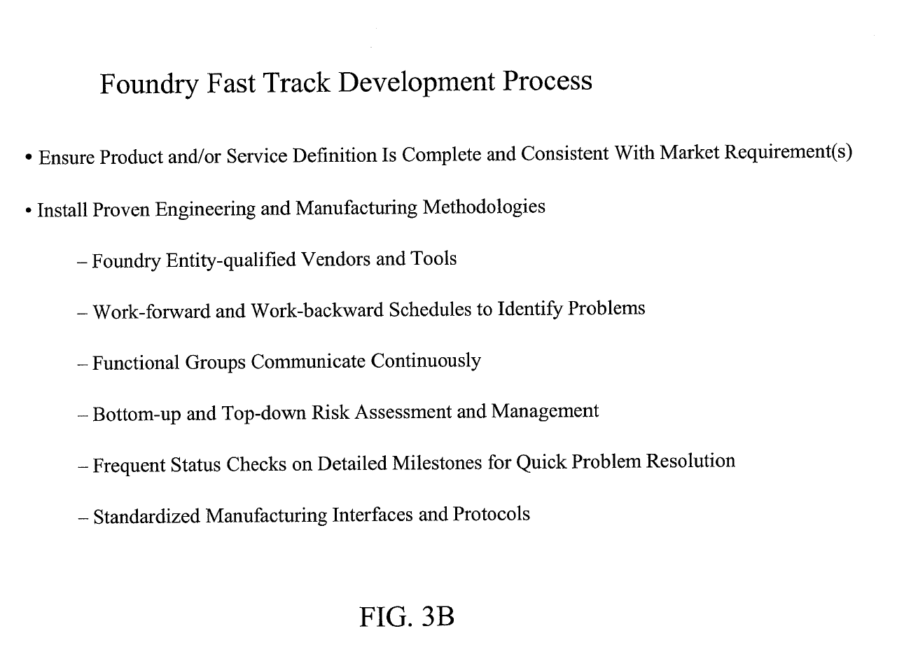

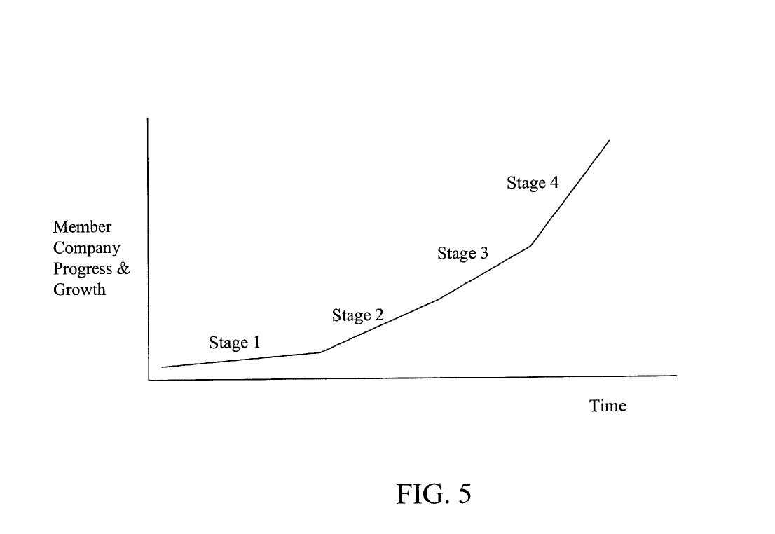

FIG. 2 is a chart showing stages of a company in the foundry system. FIGS. 3-5 are charts showing the activities that occur in each of the stages as explained in detail below. The identified stages are not necessarily sequential, as the stages begin based on the member companies' needs and status. Also, an important aspect of the invention is the existence of market and/or customer feedback during the development of the member company and its product or service. During the development, the member company business plan is modified to best address the market and customers.

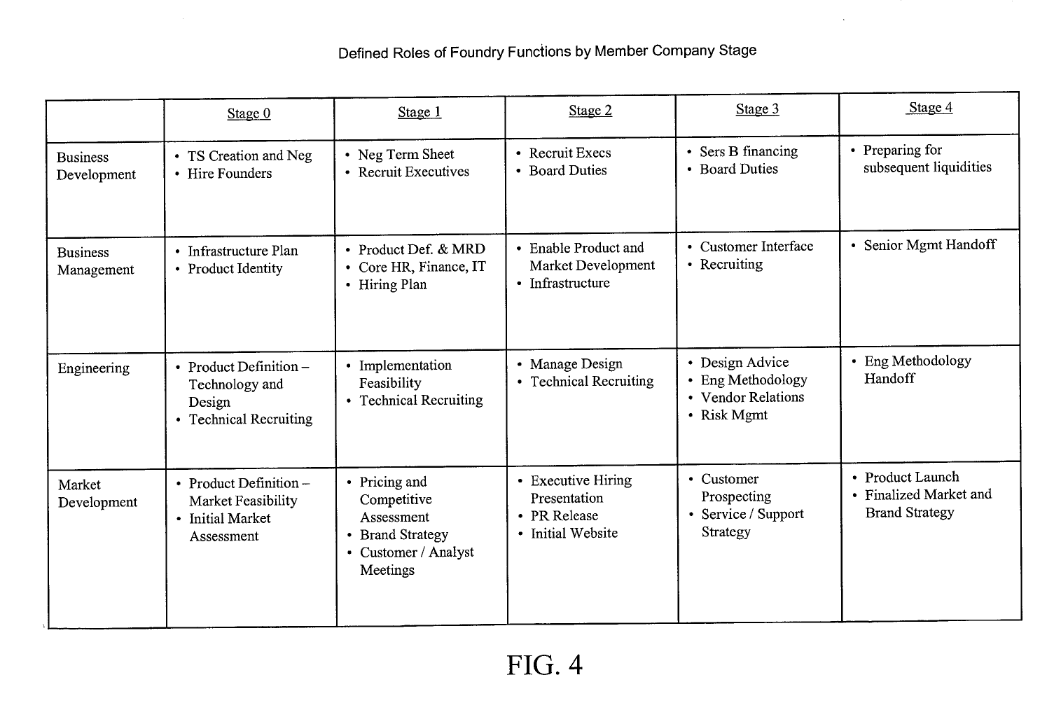

Referring to FIGS. 2, 3A-B, 4 and 5, Stage 0 involves solidifying the core technology and team that will form the member company. The co-founders and foundry entity personnel, as needed, form the core team and develop an initial plan for the member company. FIG. 4 shows the steps taken by the foundry entity and its respective departments during this stage.

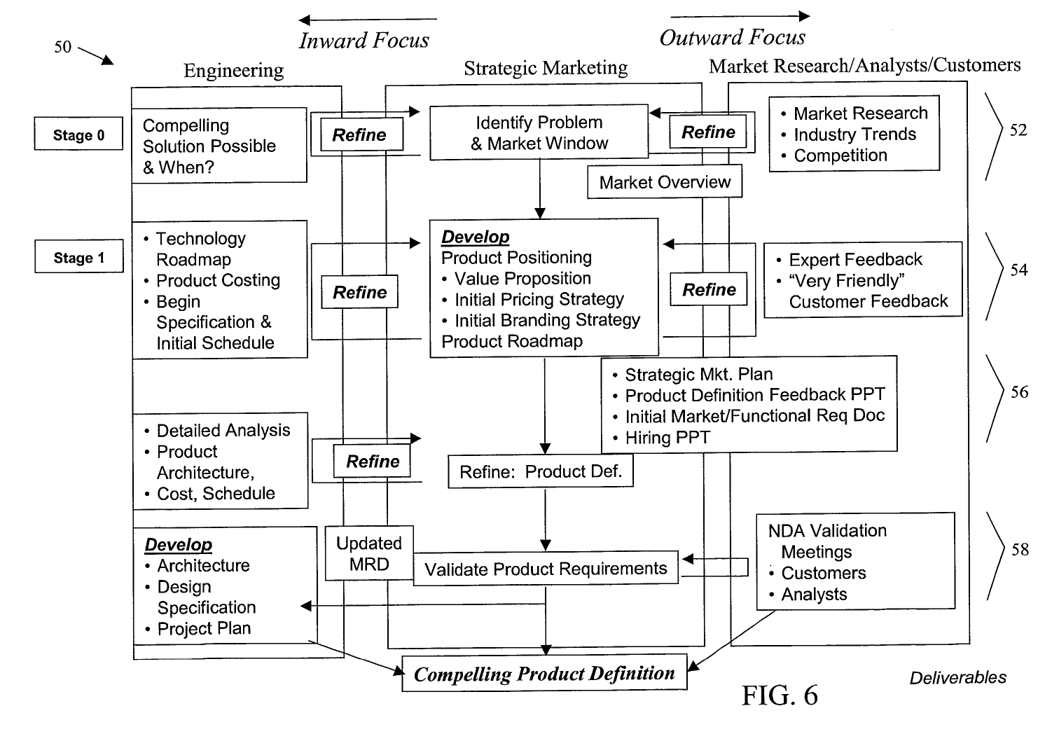

Stage 1 involves the definition of a compelling product. In order to achieve such a result, the foundry entity and the member company apply expert domain knowledge and work with product and technical experts to define the product. FIG. 4 shows the steps taken by the foundry entity and its respective departments during this stage. This is described in detail below with reference to FIG. 6.

Stage 2 involves formation of critical mass in terms of hiring employees for the member company to fill out the team. In many instances, the foundry entity employees take an active role by joining the founding team until permanent employees are hired. This results in the member company having a full world-class core team from the beginning. The foundry entity continues to assist in the recruitment of key employees who have the requisite skill and experience to fill the necessary positions with the member company. Additionally, the foundry entity and the member company begin to form key corporate alliances. FIG. 4 shows the steps taken by the foundry entity and its respective departments during this stage.

Stage 3 involves execution on the product ramp and continuing to build the member company. The member company has built critical mass, which allows it to develop and implement a detailed plan and schedule for product development, manufacturing, marketing and shipment. The foundry fast track methodology, shown in FIG. 3B, is installed, if necessary, to ensure best practices product and/or services development. FIG. 4 shows the steps taken by the foundry entity and its respective departments during this stage.

Stage 4 involves execution on member company building. Several key management personnel are hired into the member company, if they are not already in place. The member company strategy is finalized and the first product and/or service is launched. FIG. 4 shows the steps taken by the foundry entity and its respective departments during this stage.

FIG. 6 is a flow chart 50 showing development of a compelling product definition associated with Stages 0 and 1 described above. This chart is intended to represent .internal activities at the member companies where the foundry entity and personnel assist in the process, if necessary. The engineering group and strategic marketing group all play important roles in the development. In step 52, the marketing group identifies the problem and market window. The engineering group assists in determining a compelling solution and the technical viability of the solution, including the possible timing of when a viable solution is possible. The marketing group assists in reviewing market research, industry trends, customer interviews and competition to determine whether a solution to the problem matches with the market window, the viability of the engineering solution and potential profitability threshold. The problem, solution and market are iteratively refined until the foundry entity and member company management is satisfied that the member company strategy is viable.

In step 54, the marketing group assists in developing a product positioning, including a value proposition, initial pricing strategy and initial branding strategy. The marketing group also assists in proposing a product roadmap. The engineering group assists on the technological solution to the problem and assists in developing the technology roadmap and product cost estimate. The engineering group then assists in preparing the product specification and schedule. The development is iteratively refined until foundry entity and member company personnel are satisfied that the member company strategy is viable.

In step 56, the marketing group assists in developing a strategic marketing plan and assists in refining the product definition. This includes working closely with the other groups of the foundry entity and member company, and especially the engineering group to develop a detailed analysis of the product including the product architecture, cost and schedule. The development is iteratively refined until foundry entity and member company personnel are satisfied that the member company strategy is viable.

In step 58, the foundry entity assists in validating the product requirements with customers and analysts and further develops the product architecture, design and project path. The development is iteratively refined until foundry entity and member company personnel are satisfied that the member company strategy is viable.

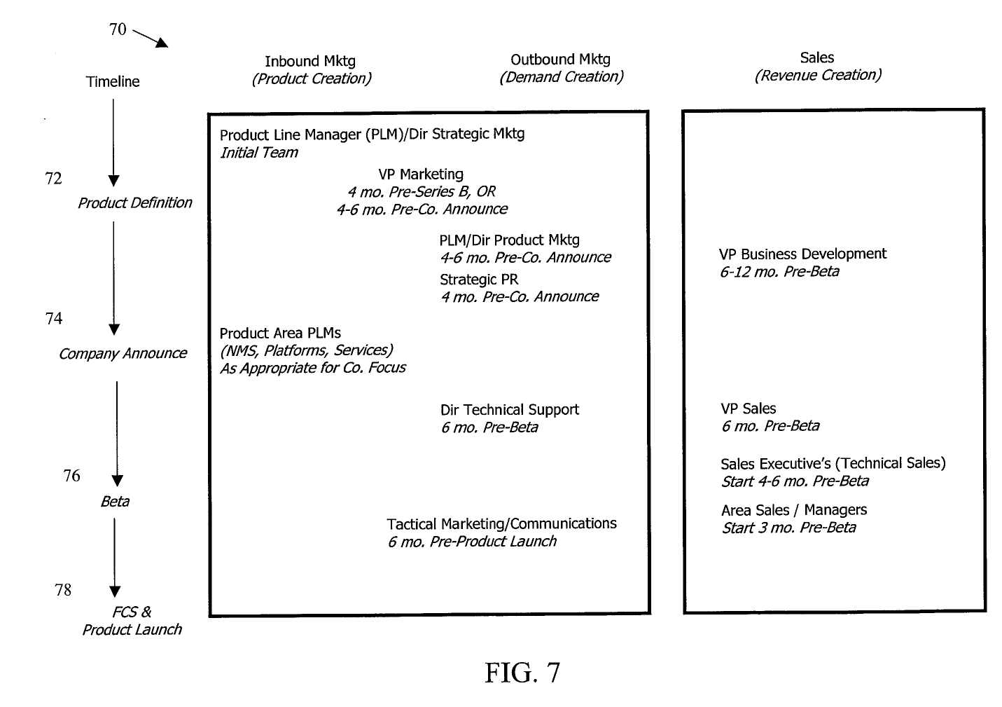

FIG. 7 is a flow chart 70 showing a development path within a member company to develop its respective sales and marketing capability related to products and/or services. In step 72, the product definition involves the initial team, where additional employees are hired based on certain milestone or events. A VP of marketing is hired at about 4 months before a second round of funding (Series B), or about 4-6 months before the company is publicly announced. A product line manager (PLM) is hired at about 4-6 months before the company is publicly announced, and a strategic public relations person is hired about 4 months before the company is publicly announced. On the sales side, a VP of business development is hired at about 6-12 months before beta test is scheduled.

In step 74, the company is publicly announced and the PLM is in charge of the various products such as the offered platform (e.g. telecommunications system, computer system, computer server, etc.) and the offered services. Also, a director of technical support and VP of sales is hired at about 6 months before beta test is scheduled.

In step 76, leading up to and including the beta test, the sales force is filled out with a number of sales executives hired at about 4-6 months before beta test is scheduled, and area sales managers are hired at about 3 months before beta test is scheduled. A tactical marketing and communications person is hired at about 6 months before product launch.

Step 78 represents the launch of the product and/or service. The member company will continue to hire personnel as it grows. The foundry entity will reduce its involvement with the member company as the member company grows and is capable of carrying on business on its own.

C. Collecting Data and Tracking Companies' Progress

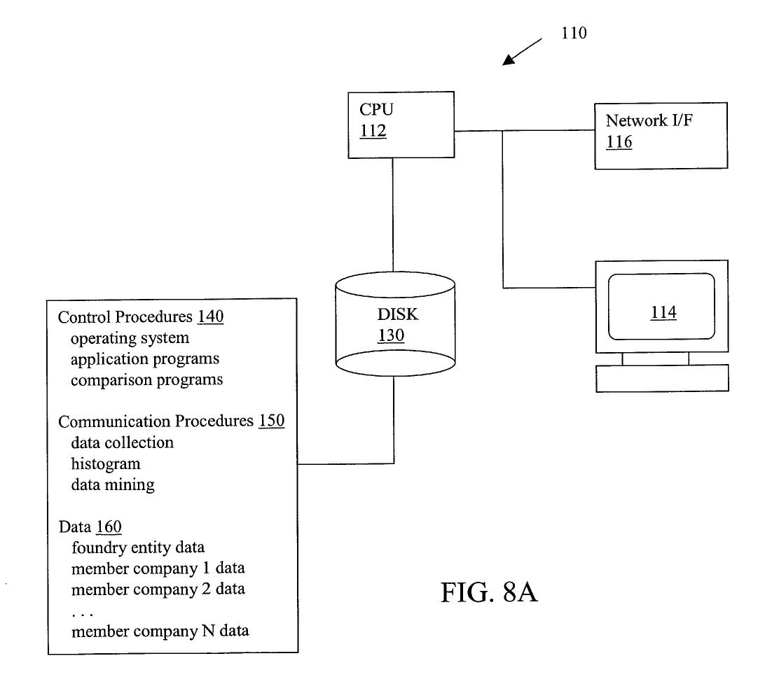

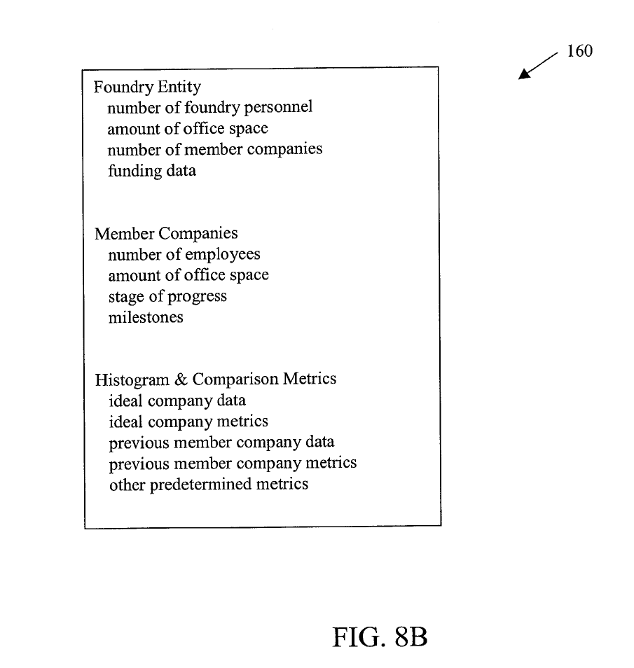

The foundry entity 12 performs progress monitoring and comparison to a number of possible metrics such as ideal best practices metrics, other member companies' metrics and/or the other companies' metrics in the outside world. One advantage of the tracking system is the ability to observe early signs of progress and potential failure so that the progress can be improved upon and the potential failure avoided by early affirmative actions. FIG. 8A shows a computer system 110 for collecting, storing, computing and tracking various attributes of the member companies as they are under development in the foundry. A central processing unit (CPU) 112 is configured to control the computer system and to run various programs to collect, store and computer various data. A user interface 114 is provided and coupled to the CPU for collecting and conveying the data to the CPU as well as displaying the data and results to the user. In the case of a remote user, a network interface 116 is provided as a conduit to communicate with the CPU. In many cases the network interface represents an Internet interface or other similar interface, which allows the computer system to be accessed by a number of users over a computer network. A memory such as a disk 130 is provided and coupled to the CPU for storing the control programs and data that the CPU will access for running various programs and for using as variables in those programs. The memory includes control procedures that the CPU executes as part of the programs stored in the computer system including an operating system and application programs, communication procedures 140 that relate to colleting the various data related to the companies, and data that pertains to the relevant foundry and member companies. The method of operation is described below.

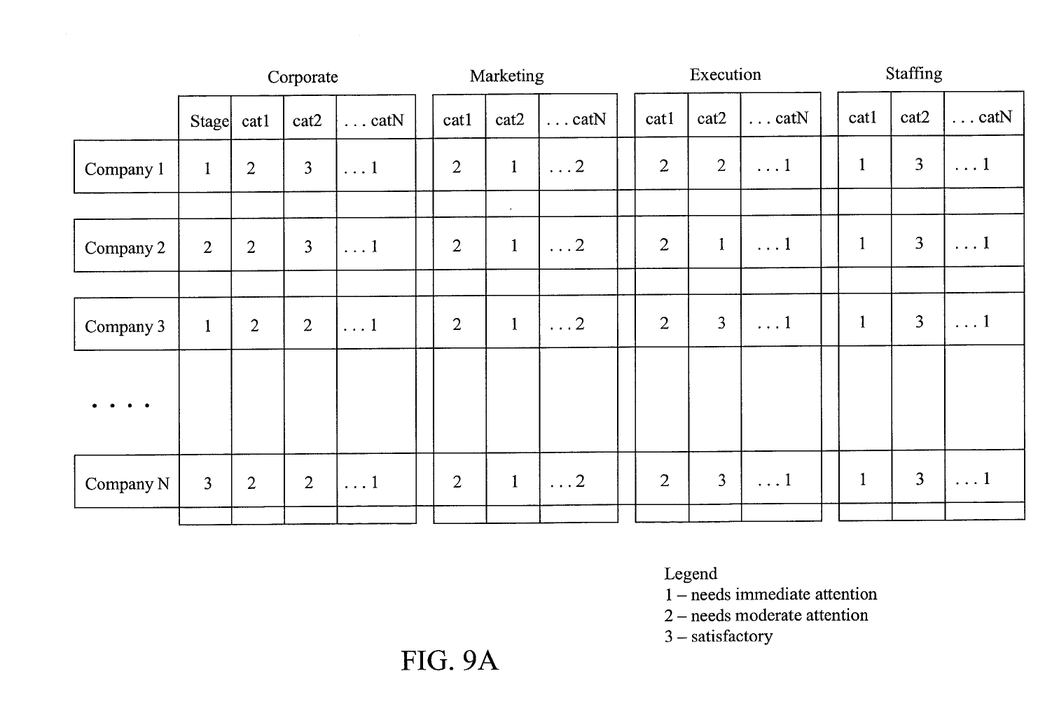

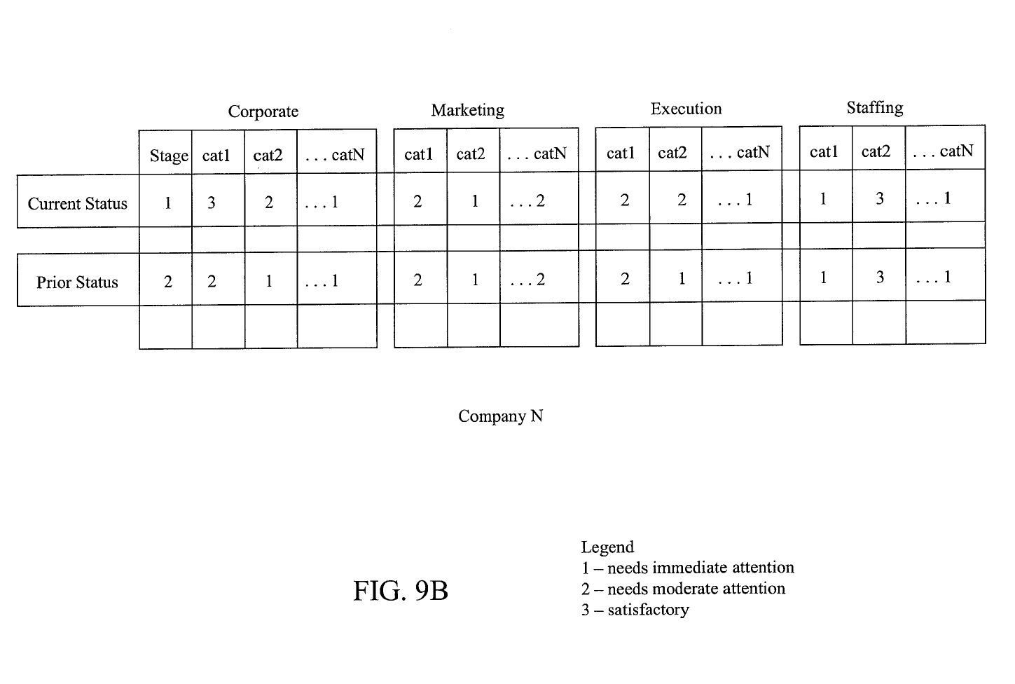

Each of the member companies in the foundry is monitored and various attributes of the companies are periodically collected and stored in a computer as shown in FIG. 8B. The attributes relate to the foundry entity, for example, the number of foundry personnel, the amount of office space, number of member companies, etc. These attributes also relate to the member companies and, for example, include number of employees, amount of financing, milestones, and other attributes described below with reference to FIGS. 9A-B. The attributes are stored as data 160 in the memory 130. In addition to the attributes, FIG. 8B shows that the data include best practices, ideal company data and metrics and past member company data and metrics, often referred to as benchmarks. The best practices, ideal company data and past member company data is used by the comparison program to compare a specific member company against this data to determine whether the specific member company is on-track relative to other companies.

FIGS. 9A-B are charts identifying the status of the member companies and the progress of the member companies based on certain attributes. Each of the member companies (company 1, company 2, . . . company N) are associated with a particular stage of development. That is not to say that they are limited to assistance associated with that stage, as mentioned above the stages are not necessarily consecutive. Each of the member companies is tracked in a number of general categories including, for example, corporate, marketing, execution and staffing. Each of these general categories is further broken down into a number of categories (cat 1, cat 2 . . . cat N).

The exemplary categories for each of the general categories are as follows. Corporate includes: development stage, corporate matters, cash positive/bum rate and foundry entity asset valuation. Marketing includes: product definition, customer traction, business model, competition and strategic alliances. Execution includes: architectural definition, prototype/power on, beta testing and first customer ship. Staffing includes: core team, critical mass, strategic marketing product line manager, VP engineering, CEO, CFO, VP manufacturing, VP marketing, VP business development and VP sales.

FIG. 9B shows a detailed chart that would be reviewed in a status meeting to determine each member company's progress since the last meeting. As shown, the member company has made progress in a number of categories where the number in the current status row is greater than then number in the prior status row. This progressive chart provides the foundry entity with a technique to store company status and observe company progress. If, for example, on the numbers decreased (meaning an increased need for attention in that category), then the foundry entity would take immediate action to rectify the problem and help to direct the member company toward increased progress.

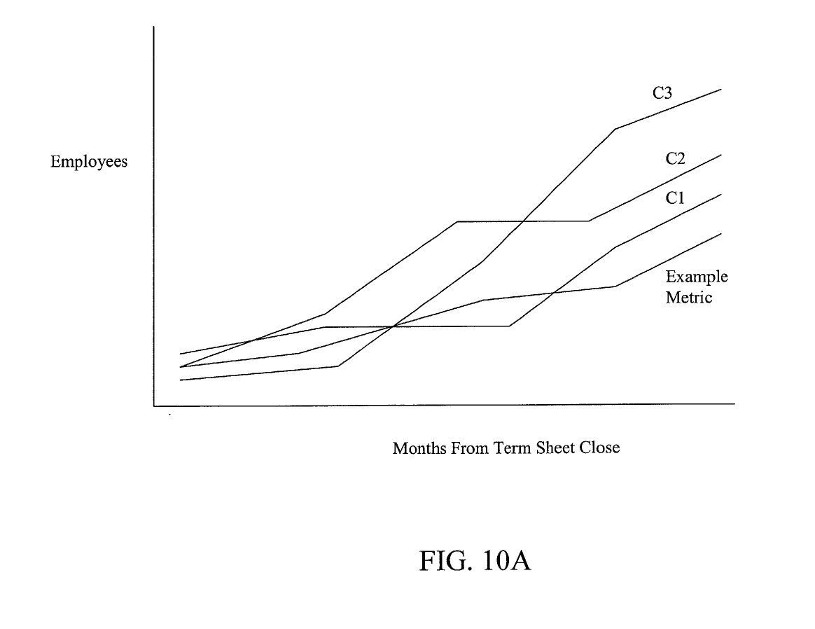

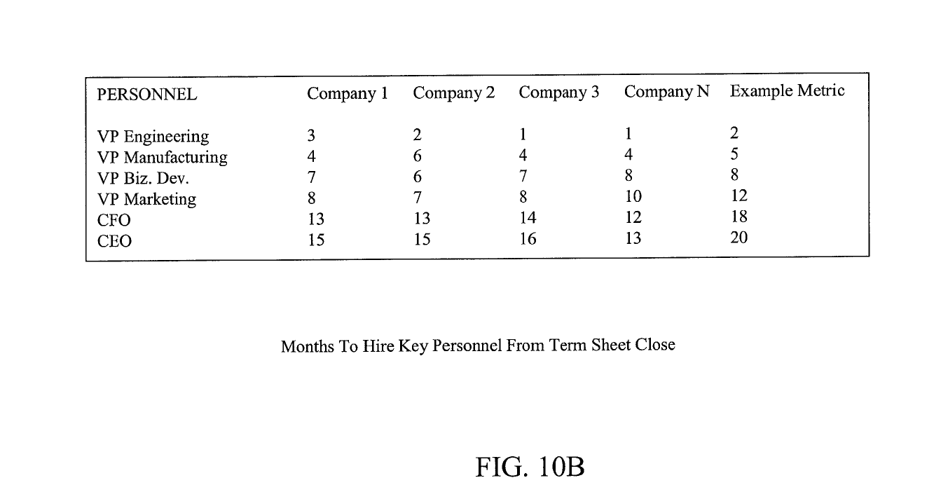

FIG. 10A shows how the member companies' attributes over time are compared to general metrics (e.g. benchmarks) and to other companies that are in development at the foundry or that have graduated from the foundry. In many cases, even once a member company graduates from the foundry, the foundry entity continues to have operating involvement in the company. Such a designation is typically given to member companies that have achieved stage 4 and beyond. In FIG. 10A, the metrics under evaluation are the months from a term sheet close (ordinarily associated with a round of financing) and committed headcount. Note the line designated as Example Metric and the other lines designated as C1 (company 1), C2 (company 2) and so on. In this manner, the foundry entity can monitor track of each of the companies' progress and assist the companies with support that is appropriate for each specific company. The Example Metric can represent, for example, an ideal best practices metric, an industry average metric, a prior companies' average metric, or other metric.

FIG. 10B shows an alternative table for comparing the months to hire key personnel from term sheet close. This table shows each of the member companies' hiring progress and the number of months to hire key personnel. Often, the top management personnel are needed as the member company reaches various milestones so the comparison can also be refined to compare companies in similar technologies to one another as well. The Example Metric can represent, for example, an ideal best practices metric, an industry average metric, a prior companies' average metric, or other metric.

With the structure implemented as described above, it is possible to more effectively perfect and execute a business plan on a more timely basis for each of many different member companies. If each of the companies within the foundry entity have the same technical orientation, the advantages become even more apparent, since the technical, marketing and management expertise that is available to the foundry entity can be fine tuned to that technical field.

D. Conclusion

It will be apparent from the description provided above that the foundry system described herein, in contrast to the conventional incubator system, provides high level guidance and core functional work to companies, which can immeasurably increase their chance of success. Rather than focusing on administrative or secretarial support for a company, which of course is needed, the invention focuses on ensuring that key positions within the member companies 20 are filled with personnel having the requisite skill and experience. As a result, decisions and execution of those decisions are typically made with a greater chance of success and implemented with greater speed, which consequently increases the chances that the member companies 20 will become successful.

The invention has been described above with reference to certain advantages including a structured environment where a group of companies can grow effectively and rapidly. Another advantage is that the companies are tracked against general metrics and specific metrics to insure that they are in schedule. Since many of the member companies are in related technical fields, the data and metrics used to track them are extremely useful for building the businesses.

While the invention has been described with reference to particular embodiments, various modifications, changes and substitutions will be apparent to those skilled in the art and are intended and anticipated in the foregoing disclosure. It will also be appreciated that in some instances some features of the invention will be employed without a corresponding use of other features while remaining within the spirit and scope of the invention as set forth in the appended claims.

What is claimed is:

1. A method for structuring a group of companies comprising the steps of:
assembling a core foundry class including a group of core foundry individuals associated with a foundry entity, the core foundry individuals including at least one first core foundry individual for providing overall corporate management guidance, at least one second core foundry individual for providing technical expertise, at least one third foundry individual for providing marketing expertise and at least one fourth foundry individual for providing legal expertise;
assembling a plurality of member companies for development by the foundry entity;
providing financial assistance from the foundry entity to each of the member companies;
determining, for each of the member companies, areas of expertise that the member company does not have, including technical, marketing and legal areas of expertise;
assigning, for each member company in each area of expertise that the member company does not have, at least one individual from the core foundry class to assist in providing that expertise to the member company; and
growing the member companies by providing active participation by each of the individuals in the core foundry class in each of the member companies to which the core foundry class individual has been assigned.

2. A method according to claim 1, further including the step of assembling a technical advisory board for each of the member companies, the technical advisory board being assembled by the foundry entity and the respective member company.

3. A method according to claim 2, wherein each technical advisory board contains at least one member who is not employed by the foundry, not employed by the member company, and has at least one of managerial and executive experience in the industry being targeted by the company.

4. A method according to claim 1, wherein a group of the member companies has a similar technical or market orientation.

5. A method according to claim 4, wherein at least two of the core foundry individuals have backgrounds consistent with the similar of technical market orientation.

6. A method according to claim 4, where the similar technical orientation is communications.

7. A method according to claim 6, wherein the similar technical orientation is broadband communications.

8. A method according to claim 7, wherein the second core foundry individual has a background in broadband communications, and at least two other core foundry individuals have a background in broadband communications.

9. A method according to claim 1, wherein one of the core foundry individuals initially sits on the board of directors for each of the member companies.

10. A method according to claim 1, further comprising the step of:
when the services of one of the core foundry individuals is no longer needed by a particular member company, reassigning the core foundry individual to assist another member company in the field of expertise of the core foundry individual.

11. A method according to claim 1, wherein the step of providing active participation includes negotiating a license on behalf of at least one of the member companies and aggregating vendor discounts.

12. A method according to claim 1, wherein the step of providing active participation includes assisting in the development of product specifications.

13. A method according to claim 1, wherein the step of providing active participation includes assisting in the construction of an integrated circuit using integrated circuit design tools.

14. A method according to claim 1, further comprising the steps of:
licensing intellectual property among the foundry entity and a group of at least one member company to increase the group of member companies' chance of success in the marketplace.

15. A method for building a group of member companies comprising the steps of:
reviewing a number of business plans including internal plans based on ideas from foundry entity personnel and external plans based on ideas from non-foundry personnel;
determining the most likely of the business plans to be successful;
assisting in the creation of member companies based at least in part on the most likely business plans, the member companies forming a first group of companies;
periodically reviewing the progress of the member companies and entering data related to the progress thereof in a computer, the data forming a first group of progress values;
comparing the progress of the member company against metrics and creating a comparison value, where at least one of the metrics is based at least in part on the first group of progress values; and
taking actions to assist the member company based at least in part on the comparison values.

16. A method according to 15, further comprising the steps of:
collecting information on each of the member companies related to their status in a number of categories;
periodically reviewing the business plans of the member companies compared to predetermined internal targets relative to each member company;
wherein the comparing step includes the step of comparing the progress of the member company against metrics in a plurality of categories and creating comparison values, at least one of the metrics based at least in part on the first group of progress values;
providing feedback to the member companies to suggest modifications to the business plans of the member companies to reach the predetermined internal targets and creating updated internal targets; and
measuring the progress of each of the member companies against the updated internal targets.

17. A method according to 16, further comprising the steps of:
providing external feedback to the companies to suggest modifications to the business plans of the companies to reach the predetermined internal targets and creating updated internal targets; and
measuring the progress of each of the companies in a plurality of categories against the updated internal targets.

18. A method according to 16, wherein:
the comparing step includes comparing the progress of the member company against ideal progress metrics, and comparing the progress of the member company against other member companies' metrics.

19. A method according to 16, further comprising the steps of:
licensing intellectual property among the foundry entity and a group of at least one member company to increase the group of member companies' chance of success in the marketplace.

20. A software structure executable on a processor for gathering data on a variety of member companies in a foundry system, storing the data in a memory, monitoring the progress of the member companies and reporting the progress of the member companies, comprising:
a control program configured to be executed by the processor and to provide for the receipt of data relative to a foundry entity and attributes of a plurality of member companies in a plurality of categories;
an input routine configured to receive data relative to the foundry entity and attributes of a plurality of member companies in a plurality of categories;
a storage routine coupled to the input routine and configured to store the data in a predetermined format;
a retrieval routine configured to retrieve the data; and
a communication routine coupled to the retrieval routine and configured to communicate the data to a user in one of a plurality of formats.

21. A software structure according to 20, for further reporting the progress of the member companies against predetermined metrics, where the memory includes stored data relative to at least one benchmark, wherein:
the attributes relative to the member companies include progress values, the data forming a first group of progress values; and
the storage routine is configured to store the first group of progress values as at least a portion of the stored data; and
the structure further comprises:
a benchmark retrieval routine configured to retrieve at least one benchmark from the memory, where at least one benchmark is based at least in part on the first group of progress values; and
a comparison routine configured to compare the data relative to attributes of a partner company against at least one benchmark and generate comparison data; and
a communication routine coupled to the comparison routine and configured to communicate the comparison data to a user in one of a plurality of formats.
